(19) United States
(12) Patent Application Publication
(10) Pub. No.: US 2010/0270706 A1
(43) Pub. Date: Oct. 28, 2010

(54) POWDER PRESS

(76) Inventors: Rolf Vest, Moenchengladbach (DE); Nikolaus Hoppenkamps, Moenchengladbach (DE); Theo Gormans, Erkelenz (DE)

Correspondence Address: KF ROSS PC, 5683 RIVERDALE AVENUE, SUITE 203 BOX 900, BRONX, NY, 10471-0900, US

(21) Appl. No.: 12/766,060

(22) Filed: Apr. 23, 2010

(30) Foreign Application Priority Data
Apr. 24, 2009 (DE) 102009018535.6
Apr. 14, 2010 (DE) 102010015016.9

(51) Int. Cl. B28B 13/02

(52) U.S. Cl. 264/293; 425/259

(57) ABSTRACT

A powder press has a lower die having an upper face and forming a cavity open upward at the face, a vertically shiftable lower piston downwardly closing the cavity, an upper piston vertically shiftable downward into the cavity, and filler shiftable between an inner position closely juxtaposed with the cavity and an outer position remote from the cavity for pouring a fluent powder into the cavity in the inner position and forming therein a powder mass. An actuator upwardly shifts the lower piston and thereby pushes up the powder mass such that a portion of it projects above the face. An element carried on the filler and shiftable over the surface scrapes away the portion of the mass projecting above the surface.

### FIELD OF THE INVENTION

The present invention relates to a powder press. This invention also concerns a method operating such a press.

### BACKGROUND OF THE INVENTION

A powder press normally has a lower die having an upper face and forming a cavity open upward at the face, and a lower piston downwardly closing the cavity and vertically shiftable to eject a finished workpiece from the lower die. An upper piston is vertically shiftable downward into the cavity to compress the mass of powder. A filler can shift between an inner position closely juxtaposed with the cavity and an outer position remote from the cavity and serves for filling the cavity with powder.

It is fairly difficult with such an apparatus to uniformly fill the cavity, especially using a filler that is slid over the cavity and that fills starting from one side. The result is therefore a workpiece where, because the powder mass in the die cavity had different densities in different locations, the resultant workpiece reflected this nonuniform density. The solution to this problem is normally fairly complex, as laid out in U.S. Pat. No. 6,656,416.

### OBJECTS OF THE INVENTION

It is therefore an object of the present invention to provide an improved powder press.

Another object is the provision of such an improved powder press that overcomes the above-given disadvantages, in particular that makes possible a high, constant, reproducible packing density with a short filling time and at the same time a high planarity of the upper face of the mass in the cavity, so that flat, larger pressed workpieces can also be produced free from defects.

### SUMMARY OF THE INVENTION

A powder press has according to the invention a lower die having an upper face and forming a cavity open upward at the face, a vertically shiftable lower piston downwardly closing the cavity, an upper piston vertically shiftable downward into the cavity, and filler shiftable between an inner position closely juxtaposed with the cavity and an outer position remote from the cavity for pouring a fluent powder into the cavity in the inner position and forming therein a powder mass. An actuator upwardly shifts the lower piston and thereby pushes up the powder mass such that a portion of it projects above the face. An element carried on the filler and shiftable over the surface scrapes away the portion of the mass projecting above the surface.

Thus the method according to the invention comprises the steps of first, with the lower piston in the lower position, shifting the filler into the inner position and pouring a fluent powder from the filler into the cavity to form therein a powder mass sitting on the lower piston. Then the lower piston is shifted upward from the lower position toward the upper position to push up the powder mass such that a portion of the mass projects above the face while sweeping the element across the cavity to push the portion to the side and level the mass at the upper face. Thereafter the upper piston is pressed down into the cavity to compress the leveled mass therein.

Excess, scraped off powder can be collected and returned to the filling system again. The scraper element is longer than the greatest horizontal dimension of the cavity at the face so that it always contacts the face to both sides of the cavity and levels the mass in the cavity perfectly flush with the lower-die face.

To make it possible for the powder filling quantities to be equally distributed in all of cavity sections, for filling, scraping off and smoothing the pressing mold cavities the hopper has the scraper unit/smoother unit arranged outside, at the front, leading in the filling movement direction, trailing in the return stroke into the starting position. Thus as the feeder is retracted the mass is automatically leveled, smoothed, and compacted slightly.

This entire device is composed of a hopper with a scraper unit/smoother unit arranged on the front side of the hopper. The hopper is closed and its lower open side slides and seals on a lower face of a plate carrying the hopper. The plate bears flush on the planar upper face of the die and has a discharge port surrounding the cavity.

The powder reaches the hopper through a supply pipe. The powder located in the hopper is transported by the linear backward and forward movement of the hopper. The backward and forward movement of the hopper is carried out by means of a linear drive.

The scraper unit/smoother unit is composed of the is following components:

a holder for the rotatable scraper axis/smoother axis,

a scraper axis/smoother axle with a smoother guide,

A drive for rotating and vertically moving the scraper/smoother axle,

a sensor system for height positioning and rotational movement,

a radiused housing on the front side of the hopper, and

a feeder table plate with a full perimeter discharge channel of the cavity for the accommodation of and discharge of the excess powder.

### BRIEF DESCRIPTION OF THE DRAWING

The above and other objects, features, and advantages will become more readily apparent from the following description, reference being made to the accompanying drawing in which:

FIGS. 1A, 1B, and 1C are partly diagrammatic top, longitudinal-sectional, and cross-sectional views of the instant invention in a starting position; and

FIGS. 2A-C, 3A-C, 4A-C, 5A-C, 6A-C, and 7A-C are views like FIGS. 1A-C showing the press of this invention in succeeding operational positions as it carries out the steps of the invention.

### SPECIFIC DESCRIPTION

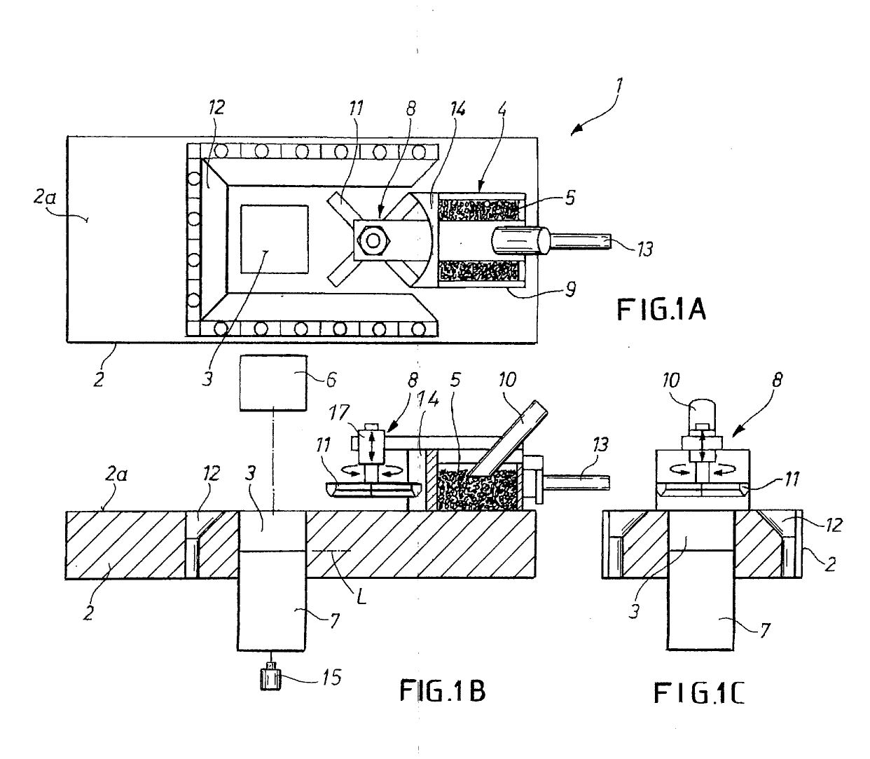

As seen in the drawing a powder press 1 according to the invention basically has a lower die 2 with a planar upper face 2a and formed with a vertically throughgoing cavity 3 in which fits a lower piston or plunger 7 that is vertically shiftable by an actuator 15 (FIGS. 1A-C only) underneath an upper piston 6 of identical section and itself vertically shiftable by a respective actuator 16 (FIGS. 7A-C only). A powder feeder 4 having a planar lower face can be slid horizontally on the upper face 2a by an actuator 13 between an end position shown in FIGS. 1A-C and 7A-C in which it is horizontally offset from the cavity 3 and an inner end position shown in FIGS. 3A-C in which it sits directly atop this cavity 3. This feeder 4 has a hopper 9 and a supply pipe 10 for fluent powder 5 to be pressed. In the inner position the hopper 9 is vertically aligned with the cavity 3, and in the outer position the hopper 9 is completely downwardly closed by the face 2a. An upwardly open U-shaped collection channel 12 extends around the cavity 3, spaced outwardly therefrom to leave a flat part of the surface 2a only interrupted by the cavity 3 for the hopper 9 to slide on. The mouth of the lower end of the hopper 9 is bigger than the upper end of the cavity 3.

A scraping and smoothing device 8 having a doctor-blade rotor 11 is carried on the feeder 4. The rotor 11 can be shifted vertically by an actuator/drive 17 that can also rotate it between the upper position shown in FIGS. 1A-C, 2A-C, 3A-C, and 7A-C spaced above the planar face 2a and a lower position shown in FIGS. 4A-C, 5A-C, and 6A-C in which its lower face is substantially coplanar with and can even touch the face 2a. In both the inner and outer end positions of the feeder 4 to which the scraper/smoother 8 is attached, it does not extend over the cavity 3 at all, but in all the illustrated intermediate positions it does at least partially overlie this cavity 3. The feeder 4 has a part-cylindrical face 14 turned toward and closely surrounding the rotor 11

The machine operates as follows:

To start with as shown in FIGS. 1A-C (step 1) the lower piston 7 is in a lower so-called overfill position with its upper face in the cavity 3 at a lower level L. Thus the amount of powder the cavity 3 can hold is greater than the quantity necessary for a green preform to be produced. The hopper 9 is located in its outer end position. The rotor 3 is raised and spaced above the face 2a.

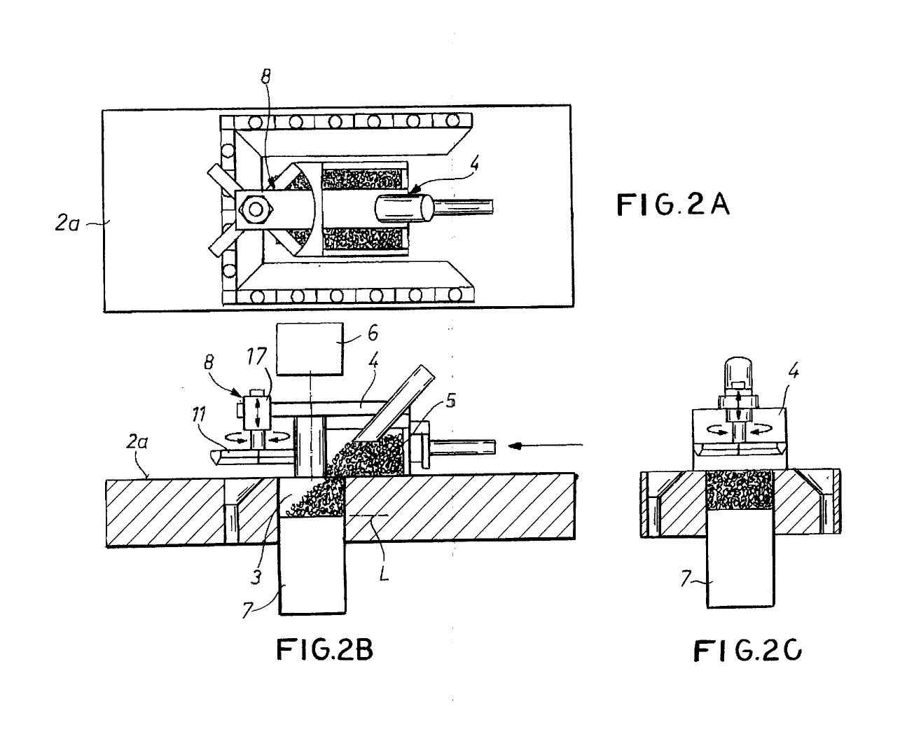

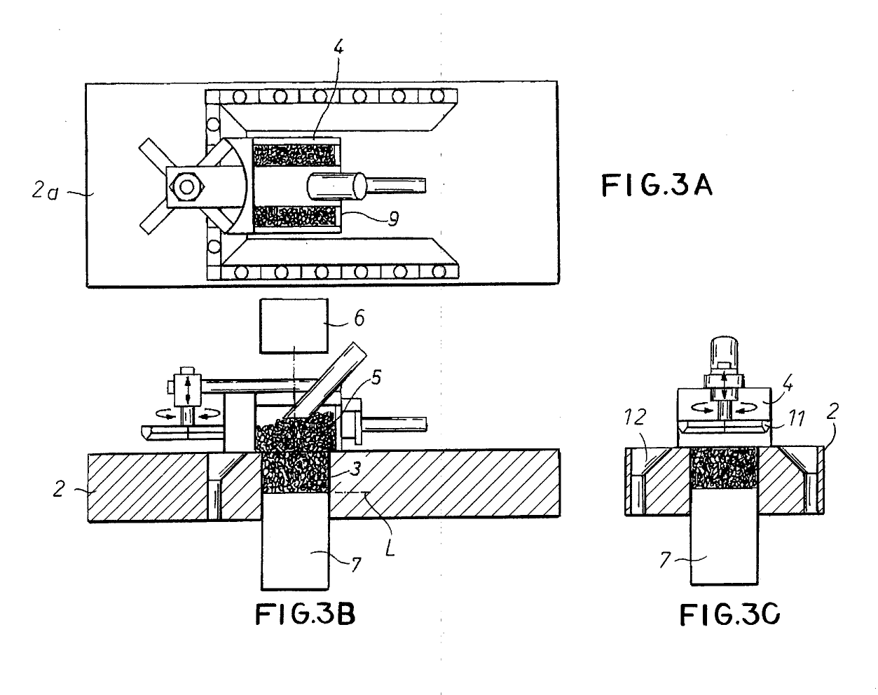

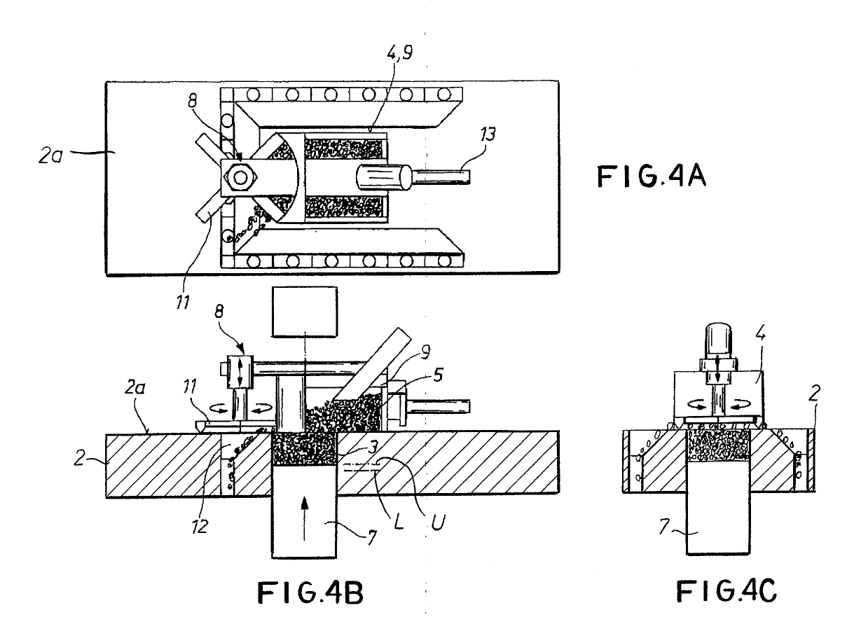

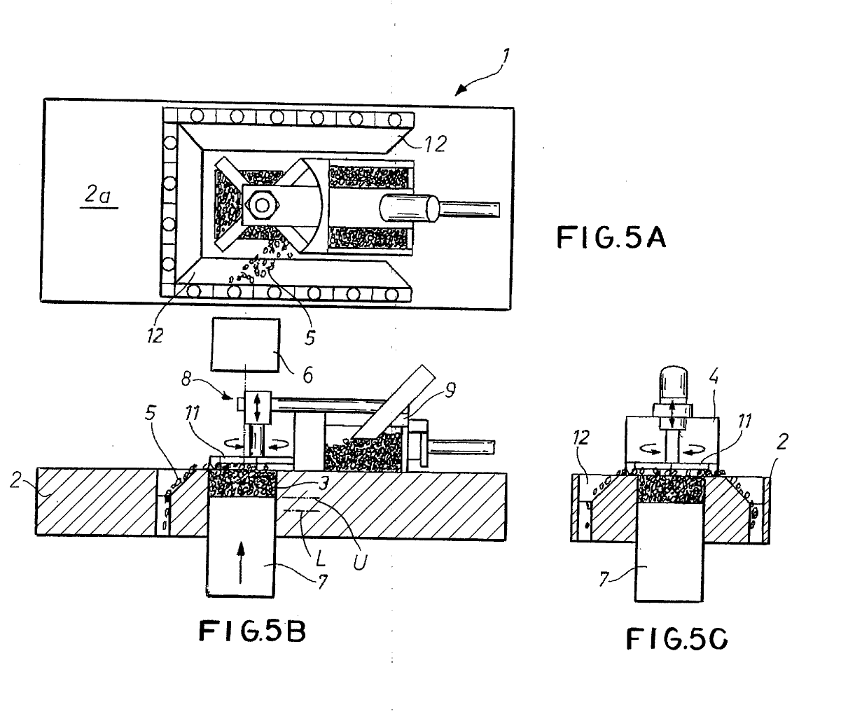

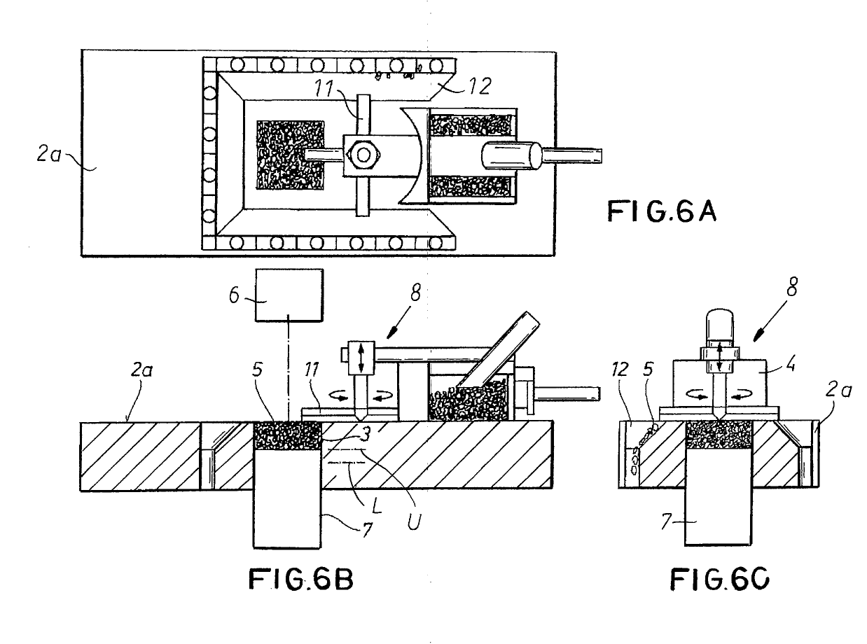

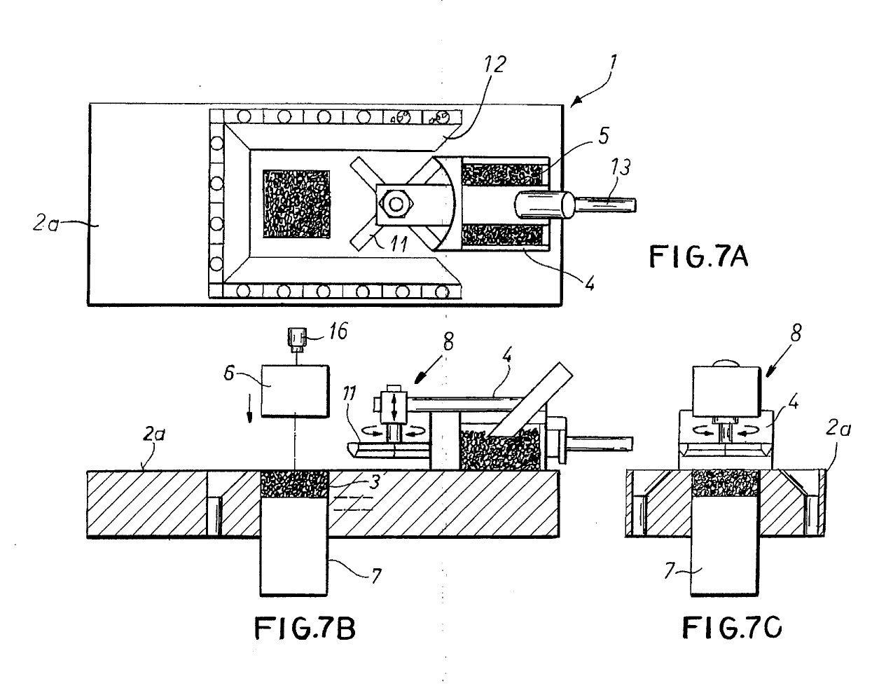

Then as shown in FIGS. 2A-C (step 2) the hopper 9 is moved forward over the die cavity 3. The powder 5 runs out of the hopper 9 into the cavity 3 and fills it up as soon as the inside edge of the hopper 9 moves beyond the outer edge of the cavity 3, thereby filling the cavity 3 from right to left as shown in FIG. 4a, for example. The rotor 11 remains in the upper position spaced above the surface 2a.

In the inner end position of FIGS. 3A-C (step 3) the hopper 9, which is somewhat wider than the cavity 3, is positioned directly over it to ensure that it is completely filled with the powder 5.

Then as shown in FIGS. 4A-C (step 4) the rotor 11 is lowered to just touch the face 3 and the feeder 4 and smoother 8 are shifted back. The rotor 11 starts to sweep the powder 5 above the plane of the face 2a to the side to fall into the channel 12. The face 14 complementary to the orbit of the rotor 11 ensures that all the powder 5 thus shifted laterally is moved into the channel 12. At the same time the lower piston 7 is moved upward somewhat to a level U above the level L to ensure that the cavity 3 is filled uniformly with respect to density with the powder 5. This combined upward shifting of the powder mass in the cavity 3 with the sweeping action of the rotor 11 ensures that the density of the mass in the cavity 3 is very uniform.

FIGS. 5A-C (step 5) shows the position when the scraping and smoothing of the powder 5 in the cavity 3 is completed. The mass of powder no longer projects above the plane of the face 2a. The lower piston has reached its upper level U.

Subsequently as shown in FIGS. 6A-C (step 6) the feeder 4 and scraper 8 are moved back toward the outer or back end position. The piston 7 remains in its upper position, the rotor 11 remains in its down position, and the bottom of the hopper 9 is closed by the face 2a.

Finally FIGS. 7A-C (step 7) show the feeder 9 and smoother/scraper 8 in the outer end position. The rotor 11 is raised and completely clear of the cavity 3. In this position the actuator/drive 16 pushes the upper piston/plunger 6 down into the cavity 3 to compress the powder mass therein.

The use of this device in connection with the described movement sequences in terms of process engineering with large-area powder pressed workpieces with only a low workpiece height or thickness and small graduations from all powdery materials that can be used for powder pressing technology shows advantages with respect to improved identical densities in all sections of the green compact, improved planarity and the maintenance of narrower height tolerances.

We claim:

1. A powder press comprising:
a lower die having an upper face and forming a cavity open upward at the face;
a vertically shiftable lower piston downwardly closing the cavity;
an upper piston vertically shiftable downward into the cavity;
filling means shiftable between an inner position closely juxtaposed with the cavity and an outer position remote from the cavity for pouring a fluent powder into the cavity in the inner position and forming therein a powder mass;
actuating means for vertically shifting the lower piston and thereby pushing up the powder mass such that a portion of it projects above the face; and
an element carried on the filling means and shiftable over the surface for scraping away the portion of the mass projecting above the surface.

2. The powder press defined in claim 1 wherein the feeding means includes a hopper and means for filling the hopper with the powder.

3. The powder press defined in claim 2 wherein the hopper is downwardly open and sits directly on the upper face such that the upper face downwardly closes the hopper in the outer end position but in the inner end position the hopper is above and opens downward into the cavity.

4. The powder press defined in claim 1 wherein the element is vertically shiftable between a position spaced above the face and a position very closely juxtaposed with or lightly touching the face.

5. The powder press defined in claim 4 wherein the element has a lower edge lying in a plane and can be swept across the cavity.

6. The powder press defined in claim 5 wherein the element is rotatable about a vertical axis to sweep it over the face and cavity.

7. The powder press defined in claim 1 wherein the upper face is formed around the cavity with an upwardly open collection channel positioned to receive the powder shifted away from the cavity by the element.

8. A method of operating a powder press comprising:
a lower die having an upper face and forming a cavity open upward at the face;
a lower piston downwardly closing the cavity and vertically shiftable between a lower position and an upper position;
an upper piston vertically shiftable downward into the cavity;
a filler shiftable between an inner position closely juxtaposed with the cavity and an outer position remote from the cavity; and
an element carried on the filling means and shiftable over the surface, the method comprising the steps of:
a) with the lower piston in the lower position, shifting the filler into the inner position and pouring a fluent powder from the filler into the cavity to form therein a powder mass sitting on the lower piston;
b) thereafter shifting the lower piston upward from the lower position toward the upper position and thereby pushing up the powder mass such that a portion of the mass projects above the face and sweeping the element across the cavity to push the portion to the side and level the mass at the upper face; and
c) thereafter pressing the upper piston down into the cavity to compress the leveled mass therein.

9. The method defined in claim 8 wherein the upward shifting of the lower piston is started when the sweeping of the element across the cavity commences.

10. The method defined in claim 9 wherein the upward shifting of the lower piston is ended with the piston in the upper position before the sweeping of the element across the cavity is ended.

11. The method defined in claim 10 wherein the element has a lower edge substantially coplanar with the upper face and is swept over the cavity by being rotated with its lower edge very closely juxtaposed with or lightly touching the upper face.
